(19) United States
(12) Patent Application Publication
(10) Pub. No.: US 2005/0049814 A1
(43) Pub. Date: Mar. 3, 2005

(54) Binding a GUI element to a control in a test executive application

(76) Inventor: Mahesh A. Ramchandani, Round Rock, TX (US)

Correspondence Address: Jeffrey C. Hood;Meyertons, Hood, Kivlin,, Kowert & Goetzel PC, P.O. Box 398, Austin, TX, 78767, US

(21) Appl. No.: 10/649,903

(22) Filed: Aug. 26, 2003

(51) Int. Cl. G06F 19/00

(52) U.S. Cl. 702/123

(57) ABSTRACT

A system and method for creating a run-time operator interface application for executing one or more test executive sequences. According to one embodiment, a first GUI element and a first control may be included in the run-time operator interface application in response to user input. A binding may be configured between the first GUI element and the first control to enable the first control to automatically perform first functionality in response to user input received to the first GUI element. In another embodiment, a second GUI element and a second control may be included in the run-time operator interface application in response to user input. A binding may be configured between the second GUI element and the second control to enable the second GUI element to automatically display first information generated by the second control.

### FIELD OF THE INVENTION

The present invention relates to the field of test executive software for organizing and executing test executive sequences. In particular, the invention relates to creating a run-time operator interface application for a test executive sequence and to a system and method for binding a GUI element to a control in the run-time operator interface application.

### DESCRIPTION OF THE RELATED ART

Test executive software is specialized software that allows a user to organize and execute sequences of reusable test modules to test units under test (UUTs). For example, the test modules may interact with one or more hardware instruments to test the UUT(s). The test modules often have a standard interface and typically can be created in a variety of programming environments. The test executive software operates as a control center for the automated test system. More specifically, the test executive software allows the user to create, configure, and/or control test sequence execution for various test applications, such as production and manufacturing test applications. Text executive software typically includes various features, such as test sequencing based on pass/fail results, logging of test results, and report generation, among others.

Test executives include various general concepts. The following comprises a glossary of test executive nomenclature, as used herein:
Code Module—A program module, such as a Windows Dynamic Link Library (.dll), LabVIEW VI (.vi), ActiveX component, or other type of program module or component, that implements one or more functions that perform a specific test or other action.
Test Module—A code module that performs a test of a UUT.
Step—An action that the user can include within a sequence of other actions. A step may call a test module to perform a specific test.
Step Module—The code module that a step calls.
Sequence—A series of steps that the user specifies for execution in a particular order. Whether and when a step is executed can depend on the results of previous steps.
Sequence File—A file that contains the definition of one or more sequences.
Sequence Editor—A program that provides a graphical user interface for creating, editing, and debugging sequences.
Run-time Operator Interface Application—A program that provides a graphical user interface for executing sequences, e.g., on a production station. A sequence editor and run-time operator interface can be separate application programs or different aspects of the same program.
Test Executive Engine—A module or set of modules that provide an API for creating, editing, executing, and debugging sequences. A sequence editor or run-time execution operator interface may use the services of a test executive engine.
Application Development Environment (ADE)—A programming environment such as LabVIEW, LabWindows/CVI, Microsoft Visual C++, Microsoft Visual Basic, etc., in which the user can create test modules and run-time operator interfaces.
Unit Under Test (UUT)—The device or component that is being tested.

Thus, the user may use the sequence editor to construct a test executive sequence comprising a plurality of steps. The test executive sequence may then be executed to perform tests of a system or UUT, e.g., via a run-time operator interface application.

### SUMMARY

One embodiment of the present invention comprises a system and method for creating a test executive application that provides a graphical user interface for executing one or more test executive sequences. Such a test executive application is also referred to herein as a run-time operator interface application. The graphical user interface of the test executive application may display any of various types of information regarding the test executive sequence and may enable a user, e.g., a test operator, to control execution of the test executive sequence in any of various ways.

According to one embodiment, a first graphical user interface (GUI) element may be included in the test executive application in response to user input. As used herein, the term “GUI element” may comprise an element on a graphical user interface. The first GUI element included in the test executive application may be operable to receive user input during execution of the test executive application. In various embodiments, the first GUI element may comprise any kind of GUI element operable to receive user input. Examples of GUI elements for receiving user input include buttons, text input elements, selection rings, check boxes, etc.

A first control may also be included in the test executive application in response to user input. The first control may include pre-existing first functionality. In other words, the first control may have pre-existing program instructions that implement the first functionality. In various embodiments, the first functionality may comprise functionality of any kind. In one embodiment, the first functionality may include test executive functionality, such as functionality for managing execution of a test executive sequence and/or displaying information regarding execution of a test executive sequence. Exemplary functions that may be performed by the first control are described below.

A binding may also be configured between the first GUI element and the first control. Configuring the binding between the first GUI element and the first control may enable the first control to automatically perform the first functionality in response to user input received to the first GUI element. When the test executive application is executed, a graphical user interface including the first GUI element may be displayed, and user input may be received to the first GUI element. The user input received to the first GUI element may cause the first control to perform the first functionality. In one embodiment, the user input may be utilized in performing the first functionality. In other words, the first functionality may vary depending on the user input received to the first GUI element.

Thus, configuring the binding between the first GUI element and the first control may enable the user to configure the test executive application to perform the first functionality in response to user input received to the GUI element without requiring the user to program the test executive application to perform the first functionality and without requiring the user to program the test executive application to respond to user input received to the GUI element. The user may simply specify the binding between the first GUI element and the first control without being required to create program code to implement the first functionality or create program code to respond to user input received to the GUI element.

In another embodiment, a second GUI element may be included in the test executive application in response to user input. The second GUI element may be operable to display information during execution of the test executive application. In various embodiments, the second GUI element may comprise any kind of GUI element operable to display information. Examples of GUI elements for displaying information include list boxes, text fields, graphs, etc.

A second control may also be included in the test executive application in response to user input. The second control may include pre-existing second functionality. The second functionality may include functionality for generating first information. In various embodiments, the second functionality may comprise functionality of any kind, and the first information may comprise information of any kind. In one embodiment, the second functionality may include test executive functionality. Exemplary functions that may be performed by the second control are described below.

A binding may also be configured between the second GUI element and the second control. Configuring the binding between the second GUI element and the second control may enable the second GUI element to automatically display the first information when the second control performs the second functionality and generates the first information during execution of the test executive application. Thus, when the test executive application is executed, a graphical user interface including the second GUI element may be displayed. The second control may execute to perform the second functionality and generate the first information during execution of the test executive application, and the second GUI element may automatically display the first information.

Thus, including the second control in the test executive sequence may enable the user to configure the test executive application to perform the second functionality without requiring the user to program the test executive application to perform the second functionality. Configuring the binding between the second GUI element and the second control may enable the user to configure the test executive application to display the first information without requiring the user to program the test executive application to display the first information. The user may simply specify the binding between the second GUI element and the second control without being required to create program code to implement the second functionality or create program code for displaying the first information.

Although the above description refers to a test executive application, it is noted that a similar technique may be utilized to simplify the creation of various other types of software applications. As one example, the above-described method may be applied to create a measurement application, e.g., a software application operable to perform a test and/or measurement function, control and/or model instrumentation or industrial automation hardware, perform a modeling and simulation function, etc. For example, the user may include a first GUI element and a first control in a measurement application, where the first GUI element is bound to the first control to cause the first control to automatically perform measurement functionality when user input is received to the first GUI element.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an instrumentation control system according to one embodiment;

FIG. 2 is a diagram representing one embodiment of the computer system illustrated in FIG. 1;

FIG. 3 is a diagram illustrating high-level architectural relationships between elements of one embodiment of a test executive environment application;

FIG. 4 illustrates one example of a test executive sequence, created according to one embodiment of a test executive environment;

FIG. 5 illustrates a user interface for a test executive step, which enables the user to specify various properties for the step that affect the way the test executive software manages the execution of the step;

FIG. 6 is a flowchart diagram illustrating one embodiment of a method for creating a run-time operator interface application;

FIG. 7 is a more detailed flowchart diagram illustrating one embodiment of a method for creating a run-time operator interface application, where the run-time operator interface application includes one or more GUI elements bound to one or more controls;

FIG. 8 illustrates an exemplary GUI element displaying a list of steps in a test executive sequence, where the GUI element is bound to a control that causes the GUI element to automatically display the list of steps;

FIG. 9 illustrates an exemplary GUI element displaying an execution hierarchy for a test executive sequence, where the GUI element is bound to a control that causes the GUI element to automatically display the execution hierarchy; and

FIGS. 10-17 are screen shots illustrating bindings between GUI elements and controls for a run-time operator interface application.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

Incorporation by Reference

The following references are hereby incorporated by reference in their entirety as though fully and completely set forth herein.

U.S. patent application Ser. No. 09/259,162 titled “Test Executive System and Method Including Step Types for Improved Configurability,” filed Feb. 26, 1999.

U.S. patent application Ser. No. 09/943,988 titled “System and Method Enabling Hierarchical Execution of a Test Executive Subsequence,” filed Aug. 31, 2001.

U.S. patent application Ser. No. 09/944,546 titled “System and Method Enabling Execution Stop and Restart of a Test Executive Sequence(s),” filed Aug. 31, 2001.

U.S. patent application Ser. No. 10/056,975 titled “Test Executive System Having XML Object Representation Capabilities,” filed Jan. 25, 2002.

U.S. patent application Ser. No. 10/056,853 titled “Test Executive System Having XML Reporting Capabilities,” filed Jan. 25, 2002.

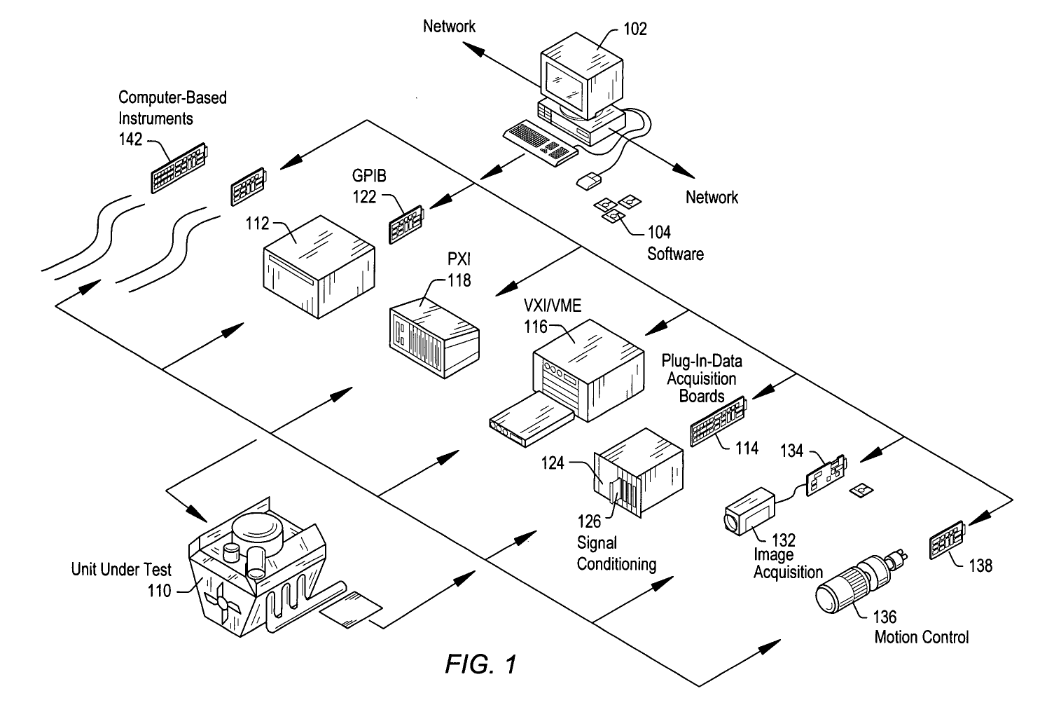

FIG. 1—Instrumentation System

FIG. 1 illustrates an exemplary instrumentation control system 100. It is noted that FIG. 1 is exemplary only, and the present invention may be used in conjunction with any of various systems, as desired. The system 100 comprises a host computer 102 that connects to one or more instruments. The host computer 102 comprises a CPU, a display screen, memory, and one or more input devices such as a mouse or keyboard as shown.

The computer 102 may create and/or execute a run-time operator interface application for analyzing, measuring, and/or controlling a unit under test (UUT) or process 150. The run-time operator interface application may invoke execution of a test executive sequence to analyze, measure, and/or control the unit under test (UUT) or process 150. For example, the test executive sequence may include various steps referencing code modules operable to connect through the one or more instruments to analyze, measure, or control the unit under test (UUT) or process 150.

The test executive sequence may have been created using a test executive environment, e.g., a sequence editor such as described below. The test executive environment may enable the test executive sequence to be programmatically invoked from a program, e.g., from the run-time operator interface application. The run-time operator interface application may include a graphical user interface displayed on the computer 102 for executing the test executive sequence. This graphical user interface may have any of various appearances, e.g., may be customized for a particular testing application or a particular test executive sequence. For example, the run-time operator interface application may be written by a user and may include a graphical user interface appropriately customized for use by test operators working in the user's production facilities, e.g., in a plant or laboratory.

The graphical user interface of the run-time operator interface application may display any of various types of information regarding the test executive sequence and may enable a user, e.g., a test operator, to control execution of the test executive sequence in any of various ways. As one example, the graphical user interface may display steps of the test executive sequence, e.g., may display a list of the steps. Various other types of information may also be displayed along with the steps of the test executive sequence, such as execution results of the steps, e.g., pass/fail results, numeric results, etc. The graphical user interface may also enable the user to invoke execution of the test executive sequence, stop or pause execution of the test executive sequence, specify a number of times to execute the test executive sequence, etc. As another example, the graphical user interface may also allow the user to view a report summarizing results of executing the test executive sequence. The graphical user interface may also allow the user to select a particular test executive sequence for execution. For example, the run-time operator interface application may be operable to invoke execution of multiple test executive sequences, e.g., together and/or separately, depending on which test executive sequence(s) is selected.

As described below, according to one embodiment of the invention, a plurality of operator interface controls may be provided to the user for use in creating the run-time operator interface application. As used herein, the term “control” may include a software component or object having associated program instructions. Each operator interface control may have functionality implemented by the associated program instructions for one or more of managing execution of a test executive sequence and/or displaying information regarding execution of a test executive sequence. The operator interface controls may facilitate the efficient creation of a run-time operator interface application. Exemplary operator interface controls and a method for creating a run-time operator interface application using one or more operator interface controls are described in more detail below.

Referring again to FIG. 1, the one or more instruments of the instrumentation control system 100 may include a GPIB instrument 112 and associated GPIB interface card 122, a data acquisition board 114 and associated signal conditioning circuitry 124, a VXI instrument 116, a PXI instrument 118, a video device 132 and associated image acquisition card 134, a motion control device 136 and associated motion control interface card 138, and/or one or more computer based instrument cards 142, among other types of devices.

The GPIB instrument 112 may be coupled to the computer 102 via a GPIB interface card 122 provided by the computer 102. In a similar manner, the video device 132 may be coupled to the computer 102 via the image acquisition card 134, and the motion control device 136 may be coupled to the computer 102 through the motion control interface card 138. The data acquisition board 114 may be coupled to the computer 102, and optionally interfaces through signal conditioning circuitry 124 to the UUT. The signal conditioning circuitry 124 may include an SCXI (Signal Conditioning eXtensions for Instrumentation) chassis comprising one or more SCXI modules 126.

The GPIB card 122, the image acquisition card 134, the motion control interface card 138, and the DAQ card 114 are typically plugged in to an I/O slot in the computer 102, such as a PCI bus slot, a PC Card slot, or an ISA, EISA or MicroChannel bus slot provided by the computer 102. However, these cards 122, 134, 138 and 114 are shown external to computer 102 for illustrative purposes. The cards 122, 134, 138 and 114 may also be implemented as external devices coupled to the computer 102, such as through a serial bus.

The VXI chassis or instrument 116 may be coupled to the computer 102 via a serial bus, MXI bus, or other serial or parallel bus provided by the computer 102. The computer 102 preferably includes VXI interface logic, such as a VXI, MXI or GPIB interface card (not shown), which interfaces to the VXI chassis 116. The PXI chassis or instrument is preferably coupled to the computer 102 through the computer's PCI bus.

A serial instrument (not shown) may also be coupled to the computer 102 through a serial port, such as an RS-232 port, USB (Universal Serial bus) or IEEE 1394 or 1394.2 bus, provided by the computer 102. In typical systems an instrument will not be present of each interface type, and in fact many systems may only have one or more instruments of a single interface type, such as only GPIB instruments.

The instruments may be coupled to the unit under test (UUT) or process 150, or may be coupled to receive field signals, typically generated by transducers. Other types of instruments or devices may be connected to the system, as desired.

In one embodiment, the computer 102 may include a memory medium on which a run-time operator interface application is stored. The memory medium may store one or more operator interface controls included in the run-time operator interface application. In one embodiment, the memory medium may also store one or more test executive sequences which may be invoked by the run-time operator interface application. In one embodiment, the memory medium may also store test executive software used in executing the test executive sequence(s), e.g., a test executive engine. In various embodiments, one or more of the software elements described above may be included on remote computer systems.

In one embodiment, the memory medium may also store software used in creating or configuring the test executive sequence(s) and/or software used in creating the run-time operator interface application. For example, the software used in creating or configuring the test executive sequence(s) may include test executive software, e.g., a sequence editor, used in specifying or configuring steps of the test executive sequence(s). The software used in creating the run-time operator interface application may include one or more application development environments (ADEs). The software used in creating the run-time operator interface application may also include a plurality of operator interface controls. In another embodiment, the test executive sequence(s) and/or the run-time operator interface application may be created on another computer system, e.g., a development computer system, and the software used in creating or configuring the test executive sequence(s) and/or the software used in creating the run-time operator interface application may not be stored on a memory medium of the computer 102.

As used herein, the term “memory medium” may include an installation medium, e.g., a CD-ROM, floppy disks 104, or tape device; a computer system memory or random access memory such as DRAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs or elements are executed or located, or the memory medium may be located in a second different computer that connects to the first computer over a network, such as the Internet. In the latter instance, the second computer may provide program instructions or data to the first computer for execution or access.

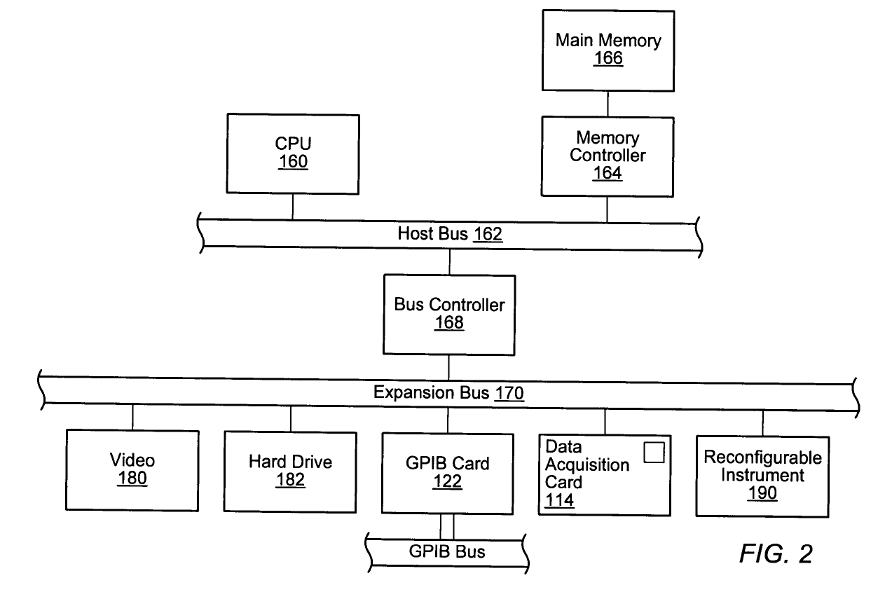

FIG. 2—Computer System Block Diagram

FIG. 2 is a diagram of the computer system 102 illustrated in FIG. 1, according to one embodiment. Where one or more of the software elements described above with reference to FIG. 1 execute on different computer systems other than the computer system 102, FIG. 2 may also represent a diagram of these computer systems. It is noted that any type of computer system configuration or architecture can be used as desired, and FIG. 2 illustrates a representative PC embodiment. It is also noted that the computer system may be a general purpose computer system, a computer implemented on a VXI card installed in a VXI chassis, a computer implemented on a PXI card installed in a PXI chassis, or other types of embodiments. Elements of a computer not necessary to understand the present invention have been omitted for simplicity.

The computer 102 includes at least one central processing unit or CPU 160 that is coupled to a processor or host bus 162. The CPU 160 may be any of various types, including an x86 processor, e.g., a Pentium class, a PowerPC processor, a CPU from the SPARC family of RISC processors, as well as others. Main memory 166 is coupled to the host bus 162 by means of memory controller 164. The main memory 166 may store software according to one embodiment of the invention, such as the software elements described above with reference to FIG. 1. The main memory 166 may also store operating system software as well as other software for operation of the computer system, as well known to those skilled in the art. The CPU 160 executing code and data from the main memory 166 may comprise a means for implementing the methods described below.

The host bus 162 is coupled to an expansion or input/output bus 170 by means of a bus controller 168 or bus bridge logic. The expansion bus 170 may be the PCI (Peripheral Component Interconnect) expansion bus, although other bus types can also be used. The expansion bus 170 may include slots for various devices such as the data acquisition board 114 (of FIG. 1) and a GPIB interface card 122 that provides a GPIB bus interface to the GPIB instrument 112 (of FIG. 1). A video display subsystem 180 and hard drive 182 coupled to the expansion bus 170 is also shown.

In one embodiment, a reconfigurable instrument 190 may also be connected to the computer 102. The reconfigurable instrument 190 may include a functional unit, also referred to as configurable logic, such as a programmable logic device (PLD), e.g., an FPGA, or a processor and memory, which may execute a real time operating system. Program instructions may be downloaded and executed on the reconfigurable instrument 190. In one embodiment, at least a portion of the software described herein may execute on the reconfigurable instrument 190. In various embodiments, the functional unit may be included on an instrument or device connected to the computer through means other than an expansion slot, e.g., the instrument or device may be connected via an IEEE 1394 bus, USB, or other type of port. Also, the functional unit may be included on a device such as the data acquisition board 114 or another device shown in FIG. 1.

Test Executive Software Components

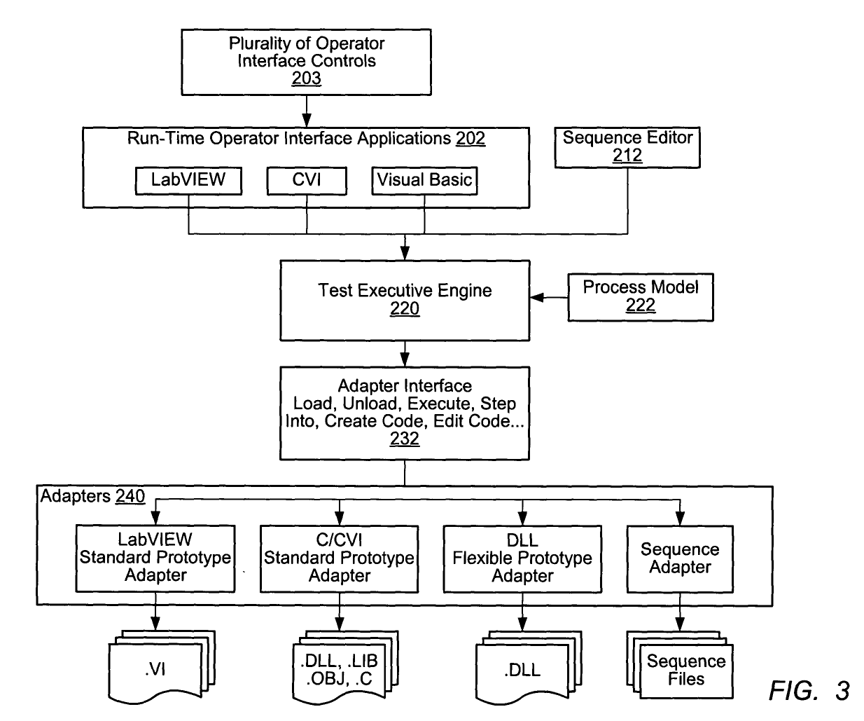

FIG. 3 is a block diagram illustrating high-level architectural relationships between elements of one embodiment of a test executive environment. It is noted that FIG. 3 is exemplary, and the present invention may be utilized in conjunction with any of various test executive environments or architectures.

The test executive environment of FIG. 3 includes a sequence editor 212 for creating and editing test executive sequences. The sequence editor 212 may interface to the test executive engine 220. In one embodiment, one or more process models 222 may couple to the test executive engine 220. The test executive engine 220 may interface through an adapter interface 232 to one or more adapters 240. The adapters 240 shown in FIG. 3 include a LabVIEW standard prototype adapter, a C/CVI prototype adapter, a DLL flexible prototype adapter, and a sequence adapter. The LabVIEW standard prototype adapter may interface to code modules having a VI extension, i.e., LabVIEW graphical programs. The C/CVI prototype adapter may interface to code modules having a .dll, .lib, .obj, or .c extension. The DLL flexible prototype adapter may interface to code modules having a .dll extension. The sequence adapter may interface to sequence files.

The test executive engine 220 may manage the execution of test executive sequences. Test executive sequences include test executive steps that may call external or user-supplied code modules. By using module adapters 240 that have the standard adapter interface 232, the test executive engine 220 may load and execute different types of code modules. Thus, the test executive may be independent from particular application development environments (ADEs) used to create the code modules. In one embodiment, the test executive may use a special type of sequence called a process model to direct the high-level sequence flow.

As shown, one or more run-time operator interface applications 202 may interface to the test executive engine 220. As described above, a custom run-time operator interface application 202 for executing one or more test executive sequences may be created by a user. Also, in one embodiment, one or more default run-time operator interface applications 202 may be provided with the test executive software, which the user may then utilize or modify. A plurality of operator interface controls 203 may be provided. The operator interface controls 203 may be utilized in creating the run-time operator interface application(s) 202, as described in detail below.

The run-time operator interface applications 202 may be written or created using any of various application development environments (ADEs). For example, the test executive engine 220 may provide an application programming interface (API) enabling programs written in various programming languages or ADEs to call the test executive engine 220. FIG. 3 illustrates the LabVIEW, LabWindows/CVI, and Visual Basic application development environments. However, in other embodiments, any of various other ADEs may be used to create a run-time operator interface application, including other Microsoft Visual Studio applications, the Delphi ADE, and Java ADEs, among others.

Test Executive Sequence Editor

The sequence editor 212 may be an application program in which the user creates, modifies, and/or debugs test executive sequences. The sequence editor 212 may have a graphical user interface (GUI) enabling a user to efficiently create a test executive sequence for testing a system or unit under test. For example, the sequence editor 212 may provide the user with easy access to test executive features, such as step types, step properties, sequence parameters, step result collection, etc.

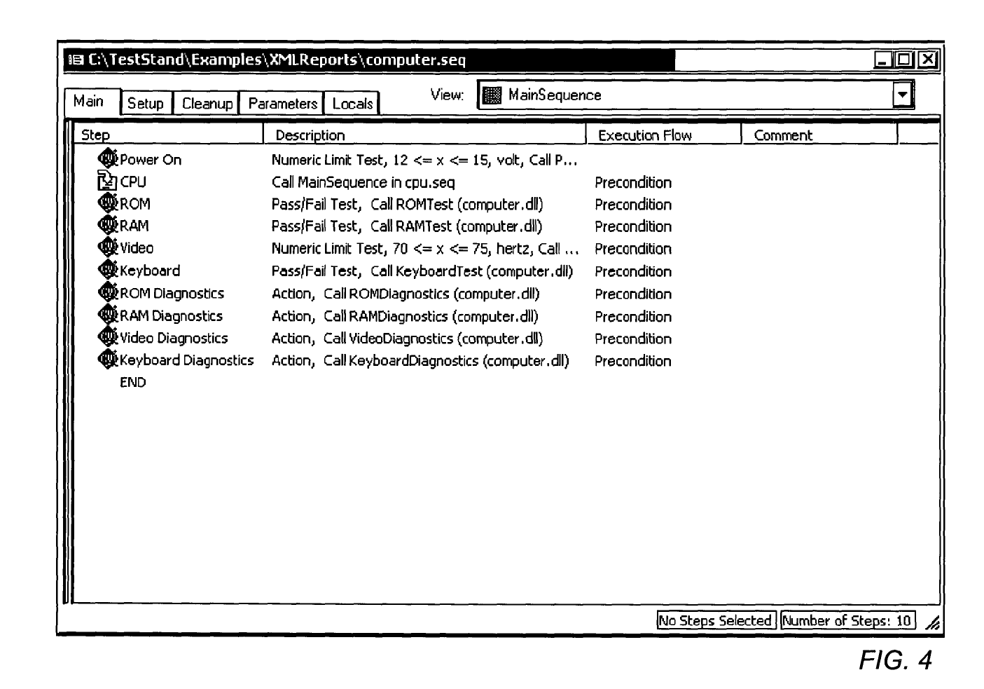

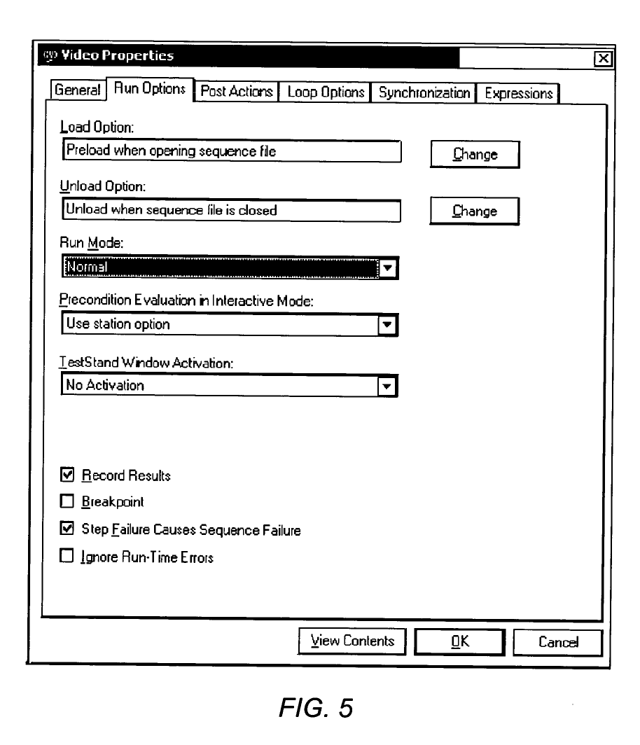

FIG. 4 illustrates one example of a test executive sequence, created according to one embodiment of a sequence editor 212. The exemplary sequence of FIG. 4 includes a plurality of test executive steps operable to test various aspects of a computer system. For example, the sequence includes a “ROM” step to test the computer's read-only memory, a “RAM” step to test the computer's random access memory, etc. Each step may call a user-supplied code module that interacts with the computer system to perform the desired test. The user may also specify various properties for each step that affect the way the test executive software manages the execution of the step. For example, FIG. 5 illustrates an exemplary dialog box for the “Video” step. As shown, a “Run Options” property page is selected in FIG. 5. The “Run Options” property page enables the user to specify various options for the step, such as whether to collect test results for the step, whether to break execution when the step is reached, whether to pre-load the step when opening the sequence file, etc.

In one embodiment, the sequence editor 212 may also include an execution window that provides debugging tools, e.g., debugging tools such as those found in application development environments such as LabVIEW, LabWindows/CVI, Microsoft Visual C/C++, Microsoft Visual Basic, etc. These may include features such as breakpoints, single stepping, tracing, a variable display, and a watch window.

Test Executive Engine

The test executive engine 220 may be used when creating, editing, executing, and debugging test executive sequences. The test executive engine 220 may also provide a test executive engine application programming interface (API) that enables another program to interface with the test executive engine 220 in order to perform these actions. For example, a run-time operator interface application may request the test executive engine 220 to execute a test executive sequence, stop execution of the test executive sequence, etc.

In one embodiment, the test executive engine 220 may export an object-based or component-based API, which in one embodiment may be an ActiveX Automation API. The sequence editor 212 and run-time operator interface applications 202 may use the test executive engine API. The engine API may be called from any programming environment able to use the API. For example, where the API comprises an ActiveX Automation API, the engine API may be called from any programming environment that supports access to ActiveX Automation servers. Thus, in various embodiments, the engine API may be called from operator interface applications or test modules written in various programming environments, including those that are written in LabVIEW, LabWindows/CVI, Microsoft Visual C++, Microsoft Visual Basic, Java, etc.

One task performed by the test executive engine 220 is to manage the execution of test executive sequences. Executing a sequence may comprise executing steps included in the sequence. Not all steps in the sequence are necessarily executed. For example, the user may configure some steps to be skipped, e.g., depending on execution results of previous steps.

For a step that references a user-supplied code module, executing the step may comprise executing the respective code module. In addition to these user-supplied code modules being executed, for each step, additional program instructions may be executed, wherein these additional program instructions implement additional functionality specified for the step. These additional program instructions may be specified by the test executive software, rather than being defined by the respective user-supplied code module for the step. As one example, when including a step in a sequence, the user may configure execution results of the step to be collected. In this example, when the step is executed, program instructions to store the step results accordingly may be executed in addition to the program instructions of a user-supplied code module that the step references.

It is noted that not all steps may reference a user-supplied code module. For example, the test executive may provide some step types that primarily affect various aspects of sequence execution and are not designed to reference user-supplied code modules.

As a test executive sequence is executed, various results may be generated, and these results may be collected, e.g., may be stored in one or more data structures. In various embodiments, the results may be generated or structured in any of various ways. For example, in one embodiment, there may be one or more results for the unit under test (UUT) as a whole, as well as results for individual steps in the sequence. The results may vary in data type as well.

Steps

As described above, a test executive sequence comprises a plurality of steps. A step can do many things, such as initializing an instrument, performing a complex test, or making a decision that affects the flow of execution in a sequence. Steps may perform these actions through several types of mechanisms, including jumping to another step, executing an expression, calling a sub-sequence or calling an external code module. The term “step module” is used to refer to the code module that a step calls.

Steps may have custom properties. For steps that call code modules, custom step properties may be useful for storing parameters to pass to the code module for the step. They may also serve as a place for the code module to store its results. The test executive API may be used to access the values of custom step properties from code modules.

In one embodiment, not all steps call code modules. Some steps may perform standard actions that the user configures using a dialog box. In this case, custom step properties may be useful for storing configuration settings that the user specifies.

Built-In Step Properties

Steps may have a number of built-in properties that the user can specify. In one embodiment, exemplary built-in step properties include:

Preconditions that allow the user to specify the conditions that must be true for the test executive to execute the step during the normal flow of execution in a sequence.

Load/Unload Options that allow the user to specify when the test executive loads and unloads the code modules or subsequences that each step invokes.

Run Mode that allows a step to be skipped or forced to pass or fail without executing the step module.

Record Results that allows the user to specify whether the test executive collects the results of the step.

Step Failure Causes Sequence Failure that allows the user to specify whether the test executive sets the status of the sequence to “Failed” when the status of the step is “Failed”.

Ignore Run-Time Errors that allows the user to specify whether the test executive continues execution normally after the step even though a run-time error occurs in the step.

Post Actions that allows the user to specify the execution of callbacks or jump to other steps after executing the step, depending on the pass/fail status of the step or any custom condition.

Loop options that allow the user to cause a single step to execute multiple times before executing the next step. The user can specify the conditions under which to terminate the loop. The user can also specify whether to collect results for each loop iteration, for the loop as a whole, or for both.

Pre Expression that allows the user to specify an expression to evaluate before executing the step module.

Post Expression that allows the user to specify an expression to evaluate after executing the step module.

Status Expression that allows the user to specify an expression to use to set the value of a “status” property of the step automatically.

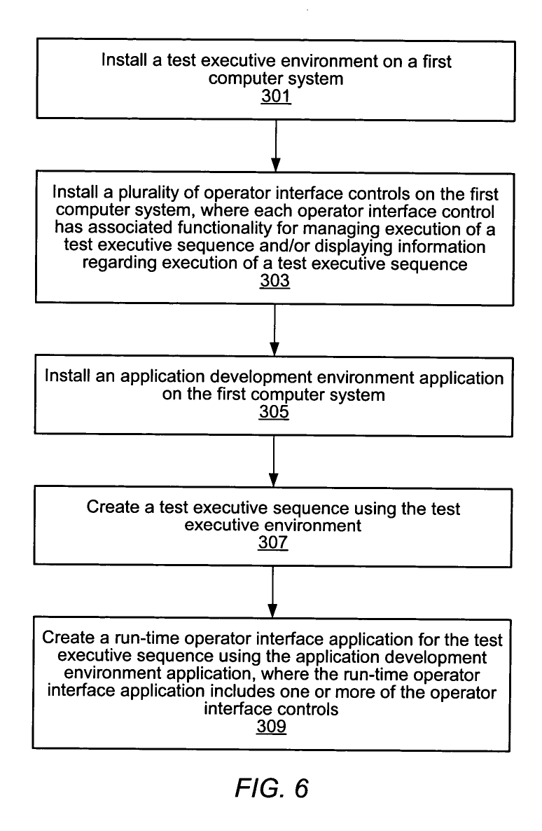

FIG. 6

FIG. 6 is a flowchart diagram illustrating one embodiment of a method for creating a test executive application that provides a graphical user interface for executing one or more test executive sequences. Such a test executive application is also referred to herein as a run-time operator interface application. The graphical user interface of the run-time operator interface application may display any of various types of information regarding the test executive sequence and may enable a user, e.g., a test operator, to control execution of the test executive sequence in any of various ways. It is noted that FIG. 6 illustrates a representative embodiment, and alternative embodiments are contemplated. Also, various elements may be combined, omitted, or performed in different orders.

In 301, a test executive environment application may be installed on a first computer system. One example of a test executive environment is the TestStand test executive environment available from National Instruments Corp. However, in various embodiments, any desired test executive environment may be used. As used herein, installing an application on a computer system may include enabling the computer system to execute the application. For example, one or more executable files associated with the application or providing access to the application may be installed on the computer system.

In 303, a plurality of operator interface controls may be installed on the first computer system. For example, files or data representing or providing access to the operator interface controls may be stored on the first computer system. In one embodiment, the plurality of operator interface controls may be installed as a part of installing the test executive environment in 301. In another embodiment, the operator interface controls may be installed separately. For example, the operator interface controls may be installed separately as a toolkit or add-on package to the test executive environment.

Each operator interface control may have associated functionality for managing execution of a test executive sequence and/or functionality for displaying information regarding execution of a test executive sequence. Exemplary operator interface controls are described below.

The operator interface controls may be implemented using any of various programming methodologies or technologies. As used herein, the term “control” may include a software component or object having associated program instructions. In one embodiment, the operator interface controls may be implemented as ActiveX controls. In other embodiments, the operator interface controls may be implemented as Java components or according to any of various other public or proprietary specifications.

In 305, an application development environment (ADE) application may be installed on the first computer system. As used herein, the term “application development environment” may include an application useable to create a computer program. Examples, of application development environments include LabVIEW and LabWindows/CVI from National Instruments, Visual Studio (e.g., Visual Basic, Visual C++, etc.) from Microsoft, Delphi from Borland, numerous Java environments from various vendors, etc.

In 307, a test executive sequence may be created using the test executive environment installed in 301. For example, the test executive sequence may be created using a sequence editor of the test executive environment, such as described above. The test executive sequence may include a plurality of test executive steps.

In 309, a run-time operator interface application for controlling execution of the test executive sequence may be created using the ADE installed in 305. In various embodiments, the run-time operator interface application may be created using any of various ADEs or any of various programming methodologies or techniques. For example, in one embodiment, the run-time operator interface application may comprise a graphical program, such as a program created in the LabVIEW graphical programming development environment. In another embodiment, the run-time operator interface application may comprise a text-based program, such as a C, C++, or Java program, among others.

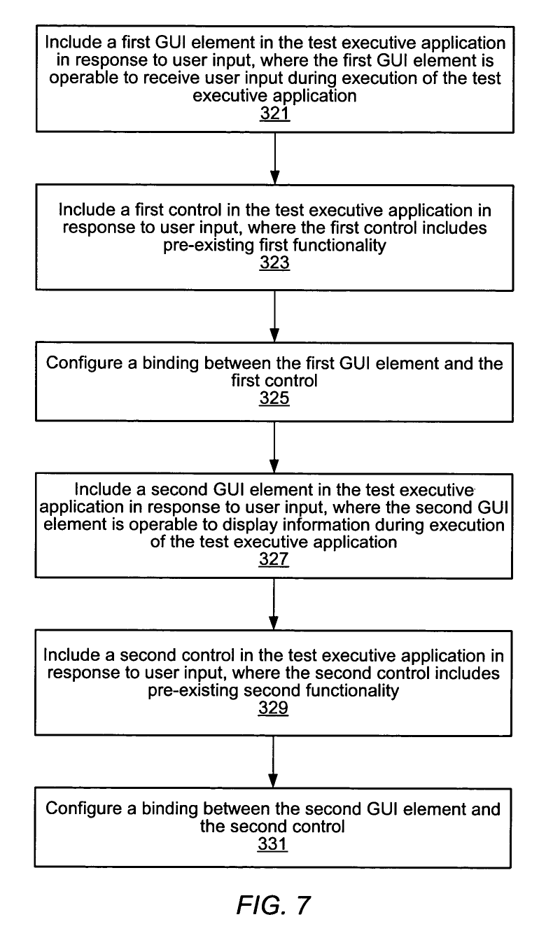

The run-time operator interface application may include or may utilize one or more of the operator interface controls installed in 303. Utilizing the operator interface controls to create the run-time operator interface application may advantageously increase the efficiency of creating the run-time operator interface application. One embodiment of 309 is discussed below with reference to FIG. 7.

FIG. 7

FIG. 7 is a more detailed flowchart diagram illustrating one embodiment of a method for creating a test executive application (run-time operator interface application), i.e., one embodiment of 309 in FIG. 6. It is noted that FIG. 7 illustrates a representative embodiment, and alternative embodiments are contemplated. Also, various elements may be combined, omitted, or performed in different orders.

In 321, a first graphical user interface (GUI) element may be included in the test executive application in response to user input. As used herein, a GUI element may comprise an element on a graphical user interface. The first GUI element included in the test executive application in 321 may be operable to receive user input during execution of the test executive application. In various embodiments, the first GUI element may comprise any kind of GUI element operable to receive user input. Examples of GUI elements for receiving user input include buttons, text input elements, selection rings, check boxes, etc.

In 323, a first control, e.g., a first operator interface control, may be included in the test executive application in response to user input. The first control may include pre-existing first functionality. In other words, the first control may have pre-existing program instructions that implement the first functionality. In various embodiments, the first functionality may comprise functionality of any kind. In one embodiment, the first functionality may include test executive functionality, such as functionality for managing execution of a test executive sequence and/or displaying information regarding execution of a test executive sequence. Exemplary functions that may be performed by the first control are described below.

In 325, a binding may be configured between the first GUI element and the first control. Configuring the binding between the first GUI element and the first control may enable the first control to automatically perform the first functionality in response to user input received to the first GUI element. When the test executive application is executed, a graphical user interface including the first GUI element may be displayed, and user input may be received to the first GUI element. The user input received to the first GUI element may cause the first control to perform the first functionality. In one embodiment, the user input may be utilized in performing the first functionality. In other words, the first functionality may vary depending on the user input received to the first GUI element.

Thus, configuring the binding between the first GUI element and the first control may enable the user to configure the test executive application to perform the first functionality in response to user input received to the GUI element without requiring the user to program the test executive application to perform the first functionality and without requiring the user to program the test executive application to respond to user input received to the GUI element. The user may simply specify the binding between the first GUI element and the first control without being required to create program code to implement the first functionality or create program code to respond to user input received to the GUI element.

In various embodiments, the first control may be operable to perform any kind of functionality in response to user input received to any kind of first GUI element. In one embodiment, the first control may be operable to select or open a test executive sequence. As one example, the first GUI element may comprise a button labeled “Open Sequence File”. The user may click this button to cause the first control to automatically display a file dialog box for browsing to the desired sequence file to open and automatically open a sequence file selected by the user. In one embodiment, the first control may also include functionality to cause the test executive steps in the selected sequence file to be displayed in a second GUI element, as described in detail below. In other embodiments, the first GUI element may not be a button, but may be another kind of GUI element. For example, the first GUI element may comprise a selection ring allowing the user to select a test executive sequence to open from one of a plurality of test executive sequences in the selection ring.

As another example, the first control may be operable to invoke execution of a test executive sequence. For example, the first GUI element may comprise a button labeled “Start Execution”. The user may click this button to cause the first control to invoke execution of a previously selected test executive sequence. Similarly, in another embodiment, the user may click a “Stop Execution” button to cause the first control to stop execution of a currently executing test executive sequence. As another example, the user may click a “Break Execution” button to cause the first control to break or pause execution of a currently executing test executive sequence, e.g., for debugging purposes.

In 327, a second GUI element may be included in the test executive application in response to user input. The second GUI element may be operable to display information during execution of the test executive application. In various embodiments, the second GUI element may comprise any kind of GUI element operable to display information. Examples of GUI elements for displaying information include list boxes, text fields, graphs, etc.

In 329, a second control, e.g., a second operator interface control, may be included in the test executive application in response to user input. The second control may include pre-existing second functionality. The second functionality may include functionality for generating first information. In various embodiments, the second functionality may comprise functionality of any kind, and the first information may comprise information of any kind. In one embodiment, the second functionality may include test executive functionality. Exemplary functions that may be performed by the second control are described below.

In 331, a binding may be configured between the second GUI element and the second control. Configuring the binding between the second GUI element and the second control may enable the second GUI element to automatically display the first information when the second control performs the second functionality and generates the first information during execution of the test executive application. Thus, when the test executive application is executed, a graphical user interface including the second GUI element may be displayed. The second control may execute to perform the second functionality and generate the first information during execution of the test executive application, and the second GUI element may automatically display the first information.

Thus, including the second control in the test executive sequence may enable the user to configure the test executive application to perform the second functionality without requiring the user to program the test executive application to perform the second functionality. Configuring the binding between the second GUI element and the second control may enable the user to configure the test executive application to display the first information without requiring the user to program the test executive application to display the first information. The user may simply specify the binding between the second GUI element and the second control without being required to create program code to implement the second functionality or create program code for displaying the first information.

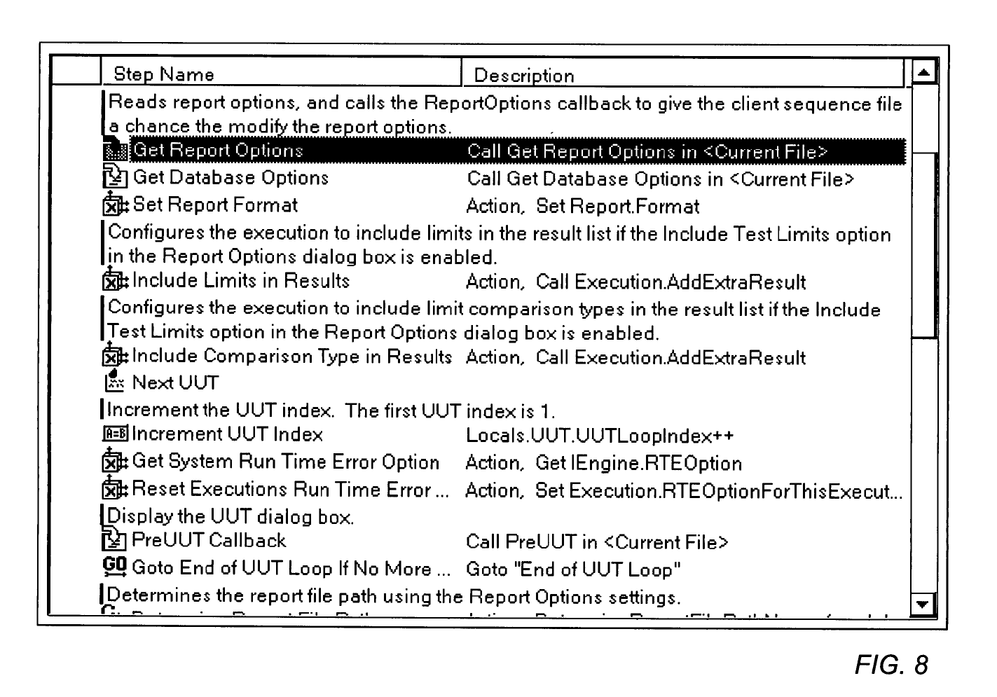

As noted above, in various embodiments, the second control may be operable to perform any kind of functionality and generate any kind of information. In one embodiment, the second control may be operable to generate first information regarding a test executive sequence or regarding execution of the test executive sequence. As one example, the second control may be operable to generate first information specifying the steps in a test executive sequence. Configuring the binding between the second GUI element and the second control may enable the second GUI element to automatically display the steps during execution of the test executive application, e.g., display the steps as a list. FIG. 8 illustrates an exemplary second GUI element displaying a list of steps in a test executive sequence.

As another example, the second control may be operable to generate a report regarding execution of the test executive sequence. Configuring the binding between the second GUI element and the second control may enable the second GUI element to automatically display the report during execution of the test executive application.

As another example, the second control may be operable to generate execution results of the test executive sequence. Configuring the binding between the second GUI element and the second control may enable the second GUI element to automatically display the execution results during execution of the test executive application.

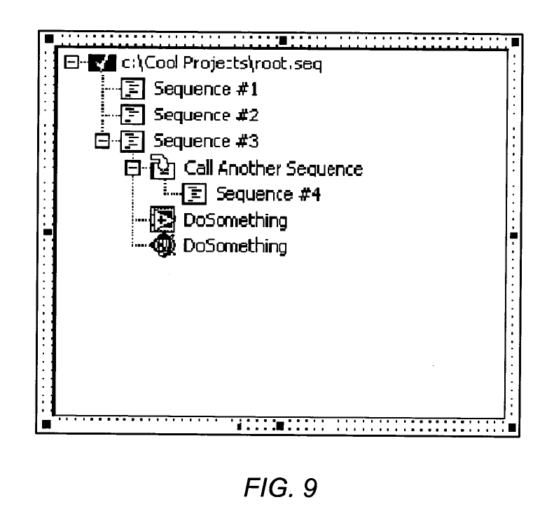

As another example, the second control may be operable to generate information indicating an execution hierarchy for the test executive sequence. Configuring the binding between the second GUI element and the second control may enable the second GUI element to automatically display the execution hierarchy during execution of the test executive application. FIG. 9 illustrates an exemplary second GUI element displaying an execution hierarchy for a test executive sequence.

Although the above description refers to a single GUI element for receiving user input (i.e., the first GUI element), in various embodiments any number of GUI elements for receiving user input may be included in the test executive application. These GUI elements may be bound to the same control or different controls. For example, in addition to the first GUI element being bound to the first control, a third GUI element may also be bound to the first control. User input received to the third GUI element may cause the first control to automatically perform third functionality (or the first functionality).

As one example, the first control may include functionality for both opening a test executive sequence file and starting execution of the sequence. In this instance, binding a GUI element to the first control may include specifying which functionality to invoke when user input is received to the GUI element. For example, an “Open Sequence File” button may be bound to the first control so as to cause the first control to open a sequence file when the “Open Sequence File” button is clicked, while a “Start Execution” button may be bound to the first control so as to cause the first control to start execution of the sequence when the “Start Execution” button is clicked. In another embodiment, the third GUI element may be bound to a different control, i.e., a third control. For example, the first control may be operable to open a sequence file, and the third control may be operable to start execution of the sequence.

Similarly, in various embodiments any number of GUI elements for displaying information may be included in the test executive application. These GUI elements may be bound to the same control or different controls. For example, in addition to the second GUI element being bound to the second control, a third GUI element may also be bound to the second control. For example, in addition to the first information, the second control may also be operable to generate second information. The third GUI element may be bound to the second control to enable the third GUI element to automatically display the second information when the second control generates the second information during execution of the test executive application.

As one example, the second control may be operable to generate information specifying a list of steps in a test executive sequence as well as information specifying execution results when the test executive sequence is executed. In this instance, binding a GUI element to the second control may include specifying which information to display in the GUI element. For example, a list box GUI element for displaying test executive steps may be bound to the second control so as to cause a list of steps in a test executive sequence to be displayed in the list box element, while a third GUI element for displaying execution results may be bound to the second control so as to cause execution results of the test executive sequence to be displayed in the third GUI element. In another embodiment, the third GUI element may be bound to a different control, i.e., a third control. For example, the first control may be operable to generate information specifying a list of steps in a test executive sequence, and the third control may be operable to generate information specifying execution results when the test executive sequence is executed.

In another embodiment, both the first GUI element for receiving user input and the second GUI element for displaying information may be bound to the same control. Thus, a single control may be operable to automatically perform functionality in response to user input received to the first GUI element and also generate information for display in the second GUI element. As one example, user input to a first GUI element (e.g., an “Open Sequence File” button) may cause the first control to open a sequence file selected by the user and also generate a list of steps in the sequence for display in the second GUI element.

In another embodiment, the first control may be “aware” of the second control. In other words, the first control may be operable to interface with the second control, e.g., by calling a method or function of the second control. As one example, user input to the first GUI element (e.g., an “Open Sequence File” button) may cause the first control to open a sequence file selected by the user and notify the second control of the selected sequence file. The second control may then generate a list of steps in the sequence for display in the second GUI element.

In another embodiment, a single GUI element may be operable to both receive user input to cause a control to perform certain functionality and to display information generated by the control when the functionality is performed. In another embodiment, the test executive application may include one or more GUI elements for receiving user input and invoking functionality of a control(s), but may not include any GUI elements for automatically displaying information generated by a control, or vice versa.

Referring again to 321 and 327, in various embodiments, the GUI element(s) may be included in the test executive application using any of various techniques. Including the GUI element(s) in the test executive application may comprise enabling the test executive application to utilize or display the GUI element(s) during execution of the test executive application. For example, the application development environment (ADE) installed in 305 may include a graphical user interface that provides access to the GUI element(s). Thus, including the GUI element(s) in the test executive application may comprise including the GUI element(s) in the test executive application in response to user input received to the graphical user interface of the ADE. For example, the user may interact with the graphical user interface of the ADE to include the GUI element(s) in a graphical user interface of the test executive application.

Similarly, in various embodiments, the control(s) may be included in the test executive application using any of various techniques. Including the control(s) in the test executive application may comprise enabling the test executive application to utilize the control(s) during execution of the test executive application. In one embodiment, including the control(s) in the test executive application may comprise including the control(s) in the test executive application in response to user input received to the graphical user interface of the ADE. The graphical user interface of the ADE may enable the user to select desired controls to include in the test executive application.

In various embodiments, the graphical user interface of the ADE may provide access to the controls in various ways, e.g., depending on the particular ADE being used and/or depending on the implementation of the controls. For example, in one embodiment, the graphical user interface of the ADE may simply provide a file dialog box enabling the user to select a filename of a desired control. In another embodiment, the graphical user interface of the ADE may be operable to display a list of available controls, e.g., in response to a user request to select a control. In another embodiment, the graphical user interface of the ADE may represent the controls visually, e.g., as an icon or picture. Thus, the control(s) may be included in the test executive application in various ways, e.g., by selecting a filename(s) of the control(s), selecting the control(s) from a list, dragging and dropping a visual representation of the control(s) into a window for the test executive application, etc.

In another embodiment, including the control(s) in the test executive application may comprise including one or more lines of source code (or a portion of graphical source code) referencing the control(s) in a program file of the test executive application to enable the test executive application to utilize the control(s).

Also, in various embodiments, the GUI element(s) may be bound to the control(s) using any of various techniques. In one embodiment, configuring the binding between a GUI element and a control may comprise performing one or more programmatic calls to bind the GUI element to the control during execution of the test executive application. Thus, the user may include one or more lines of source code (or a portion of graphical source code) in a program file of the test executive application to bind the GUI element to the control. The amount of source code required to bind the GUI element to the control is preferably very small (e.g., one or two lines) so that creating the binding is very simple for the user. In another embodiment, configuring the binding between the GUI element and the control may be performed in response to receiving user input to a graphical user interface. For example, the user may be able to invoke a property panel to set one or more properties of the GUI element and/or the control to specify the binding between the GUI element and the control.

In one embodiment, the control(s) may be operable to call into a test executive environment in order to perform test executive functionality. For example, the control(s) may call into the test executive environment used to create the test executive sequence in 307, e.g., may perform various programmatic calls to a test executive engine through an engine API, such as described above. For example, the second control may be operable to call the test executive environment to determine a list of steps in the test executive sequence and may then generate information indicating the list of steps. In another embodiment, the control(s) may themselves implement all aspects of the test executive functionality and may not call into the test executive environment.

In one embodiment, the user may also configure one or more of the controls after including the controls in the test executive application. For example, the one or more controls may be operable to perform different functionality during execution of the test executive application, depending on their configuration. The control(s) may be configured in various ways, e.g., depending on the implementation of the control(s) and/or depending on the particular ADE being used. For example, in one embodiment, each of the controls included in the test executive application may have one or more associated properties. Thus, the user may provide user input to configure properties associated with the controls. For example, in one embodiment a property panel for configuring each control may be displayed, and user input to configure the properties may be received to the property panel. For example, the property panel may include one or more separate windows or dialog boxes, or user interface elements for setting the properties may be displayed in a portion of another window. In another embodiment, properties of a control may be set programmatically during execution of the test executive application.

As one example, with respect to a control operable to cause a list of steps in a test executive sequence to be displayed, the user may configure properties of the control to customize the appearance of the displayed list of steps. For example, the user may be able to configure properties to specify a desired number of columns in the list, headings for each column, step information displayed in each column, an ordering of the columns, colors for the column data, etc. As one example, the user may configure a first column to display a name of the steps and a second column to display execution results of the steps.

It is noted that the controls described above are exemplary only, and controls that provide any of various other types of functionality may be utilized in other embodiments. In one embodiment the user may also include one or more controls having test executive functionality in the test executive application without binding the controls to GUI elements. As one example, the user may include an “engine” control in the test executive application, where the engine control is operable to interface with a test executive engine to manage execution of the a executive sequence. The engine control may be operable to perform functions such as a start procedure to start up the test executive engine, a shutdown procedure to shut down the test executive engine, etc. In one embodiment, the engine control may not receive user input from a GUI element and may not cause information to be displayed in a GUI element.

Controls such as those described above may advantageously remove the burden on the user (programmer) from implementing at least a portion of the functionality for a test executive application or run-time operator interface application. For example, a common feature for run-time operator interface applications is to display a list of steps in a test executive sequence. A control such as described above may be operable to automatically display the steps of a specified sequence and may eliminate the need for the user (programmer) to write code to perform such tasks as: obtaining a reference to a sequence file containing the test executive sequence, enumerating and obtaining references to the sequences that are in the sequence file, enumerating and obtaining information regarding steps of the desired sequence, formatting the step information appropriately, displaying the formatted information, etc. Instead, a control bound to a GUI element in the test executive application may automatically perform these tasks.

Although the above description refers to a test executive application, it is noted that a similar technique may be utilized to simplify the creation of various other types of software applications. As one example, the above-described method may be applied to create a measurement application, e.g., a software application operable to perform a test and/or measurement function, control and/or model instrumentation or industrial automation hardware, perform a modeling and simulation function, etc. For example, the user may include a first GUI element and a first control in a measurement application, where the first GUI element is bound to the first control to cause the first control to automatically perform measurement functionality when user input is received to the first GUI element.

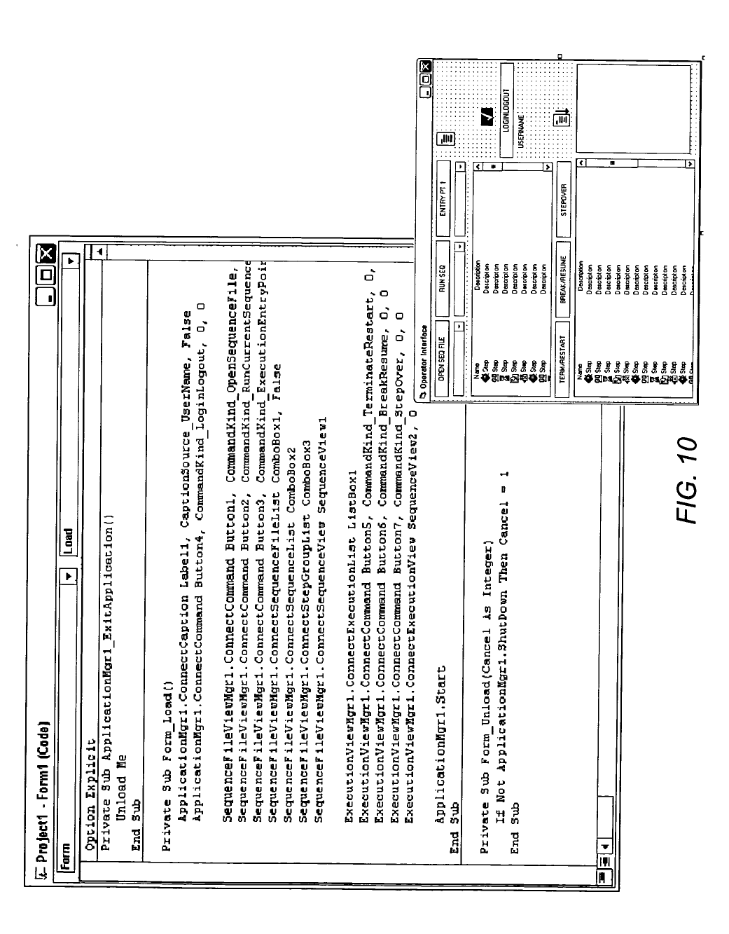

As noted above, in one embodiment, the user may include one or more lines of source code in a program file of the test executive application to bind a GUI element to a control. FIG. 10 illustrates a portion of Visual Basic source code for binding GUI elements to controls. For example, the following line of source code is illustrated:
SequenceFileViewMgr1.ConnectCommand Button2,
   CommandKind_RunCurrentSequence, 0, 0

This line may cause a GUI button (referenced as Button2) to be bound to a “SequenceFileViewMgr” control. The CommandKind_RunCurrentSequence parameter specifies that operation of the button causes the “SequenceFileViewMgr” control to run the currently selected test executive sequence. Thus, the binding may implement a fairly large amount of functionality with a relatively small amount of code and may allow the user to easily configure the test executive application to invoke execution of a test executive sequence.

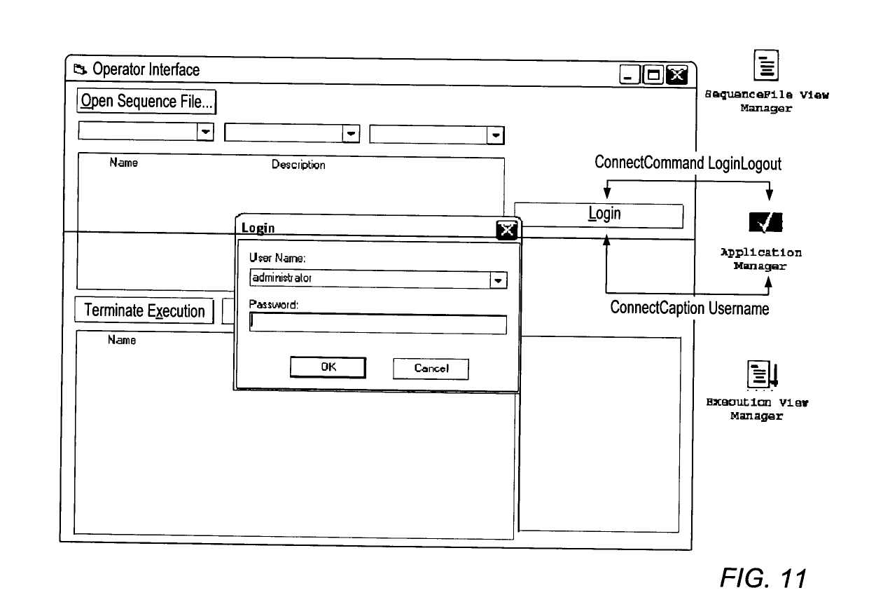

FIG. 11 illustrates an exemplary graphical user interface for a test executive application (run-time operator interface application), where GUI elements in the graphical user interface have been bound to controls as indicated by the source code of FIG. 10. Three controls (Sequence File View Manager, Application Manager, and Execution View Manager) are also illustrated to the side of the graphical user interface to illustrate the respective bindings. As indicated, the Login/Logout button is bound to the Application Manager control. When the user provides input to the Login/Logout button, the Application Manager control executes to update the appearance of the Login/Logout button and the user name shown. In FIG. 11, a user is not currently logged in, and thus the GUI elements in the graphical user interface are disabled, and the user name caption is empty. A Login routine is running (login prompt is displayed), and thus the Login button is disabled.

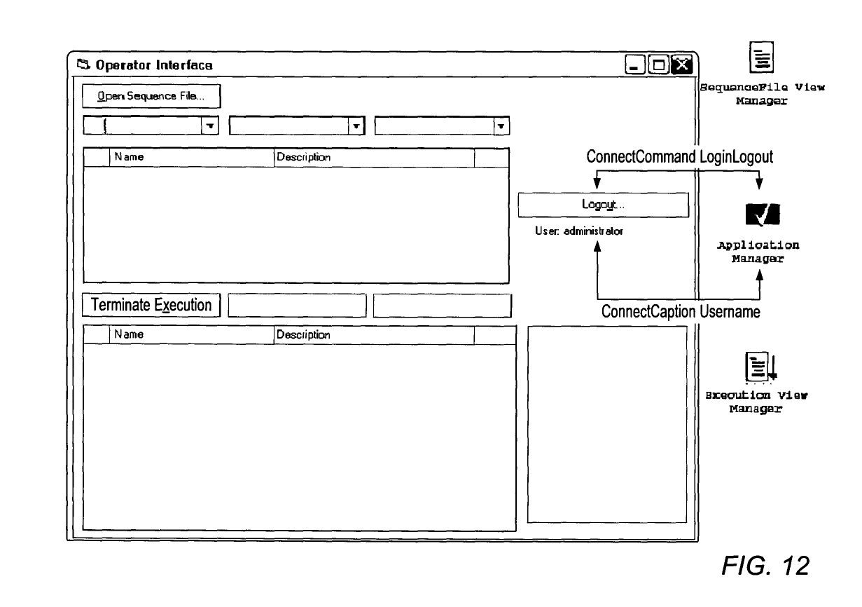

FIG. 12 illustrates the graphical user interface of FIG. 11 after the user has logged in. When the user logs in, the Application Manager control automatically changes the Login button label to “Logout” and displays a caption with the appropriate username (“administrator” in this example).

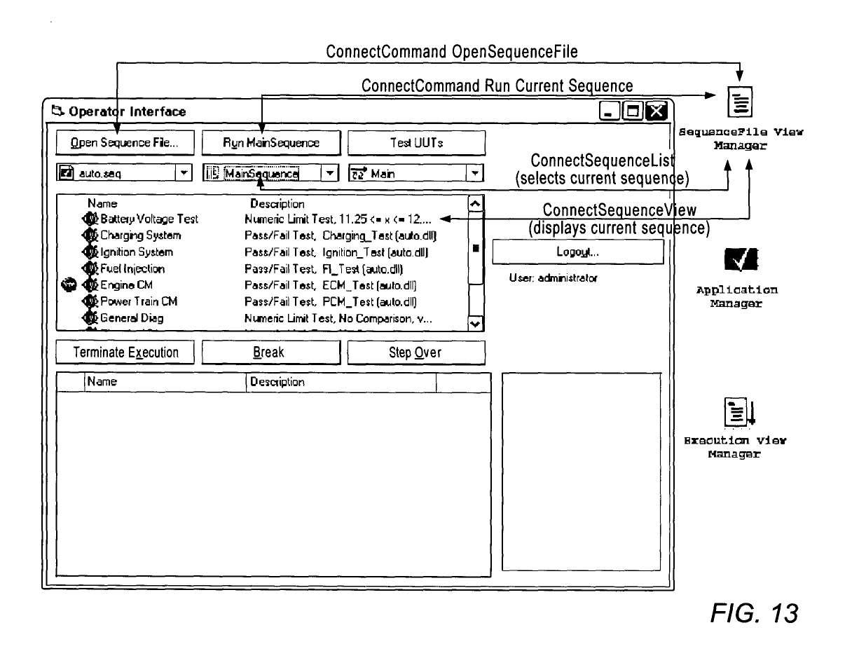

FIG. 13 is a screen shot illustrating use of the graphical user interface of the run-time operator interface application. As shown, the Open Sequence File button and the Run MainSequence button are bound to the SequenceFile View Manager control. The Sequence List list box is also bound to the SequenceFile View Manager control. When the user provides input to either the Open Sequence File or the Run MainSequence buttons, or to the Sequence List list box, the SequenceFile View Manager control may automatically perform various operations. In this example, MainSequence is the currently selected sequence. Hence the Run Current Sequence command button is labeled, “Run MainSequence”.

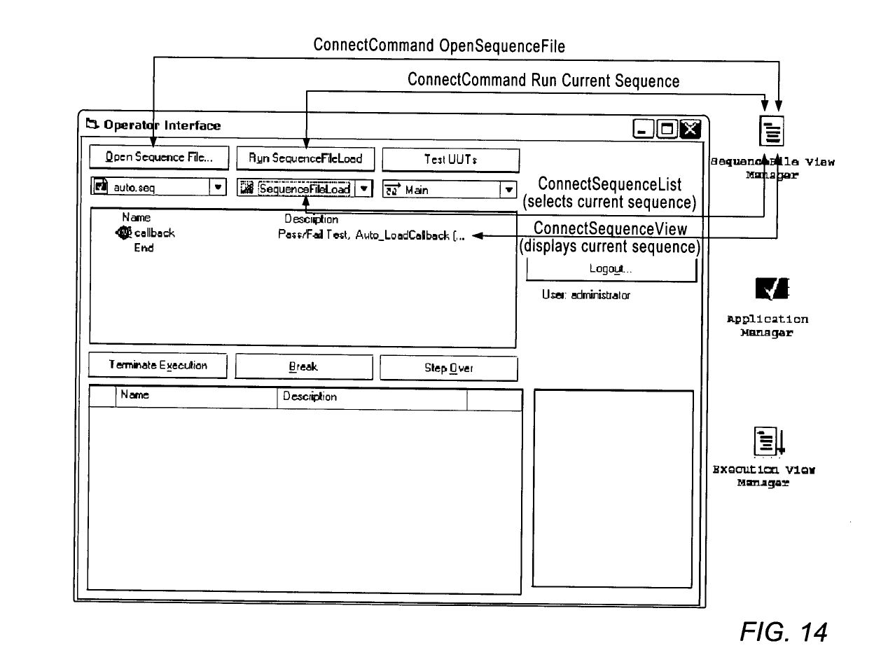

FIG. 14 is a screen shot illustrating the graphical user interface after the user has used the Open Sequence File button to change the sequence to another sequence called “SequenceFileLoad”. When the user uses the Open Sequence File button to change the current sequence, the SequenceFile View Manager control operates to automatically adjust the information in the Sequence View window accordingly. As shown, the SequenceFile View Manager also operates to automatically update the appearance of the Run Current Sequence command button to say “Run SequenceFileLoad”.

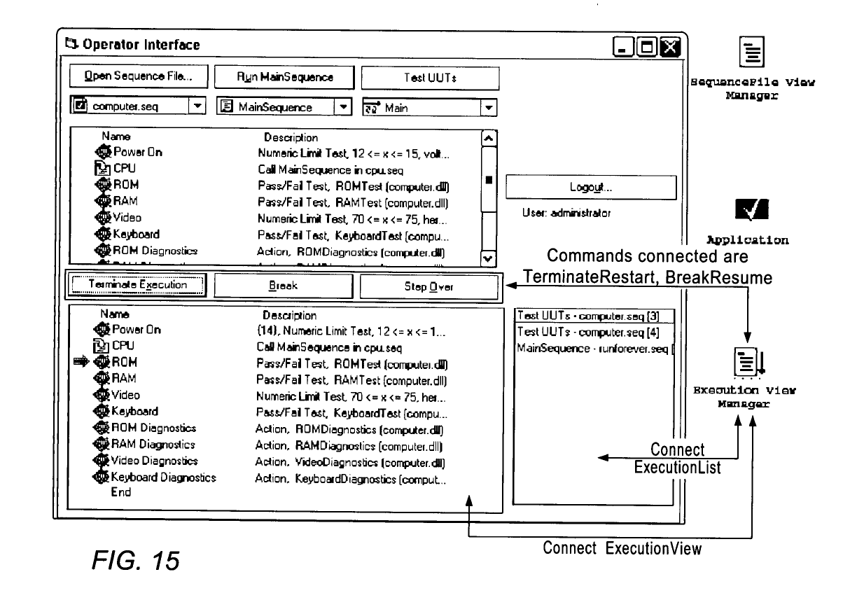

FIG. 15 is a screen shot of the graphical user interface illustrating execution of a sequence. As shown, the Terminate Execution, Break, and Step Over buttons are all connected to the Execution View Manager control. When the user provides input to (e.g., presses) these buttons, the Execution View Manager control may execute to update one or more of the Execution View window or Execution List window, as needed, and also update the appearance of the respective buttons. In FIG. 15 the user has created a few executions of the MainSequence sequence by clicking the Run MainSequence and Test UUTs buttons. The execution list is populated with the created executions. In FIG. 15, the currently selected execution is the “TestWUTs—computer.seq [3]” execution. Since the sequence is currently running, the user can click the Terminate Execution button to terminate execution of the sequence. Similarly, because the sequence is running, the user can click the Break button to break execution of the sequence, but cannot click the Step Over button. (The execution needs to be paused to be able to step over.)

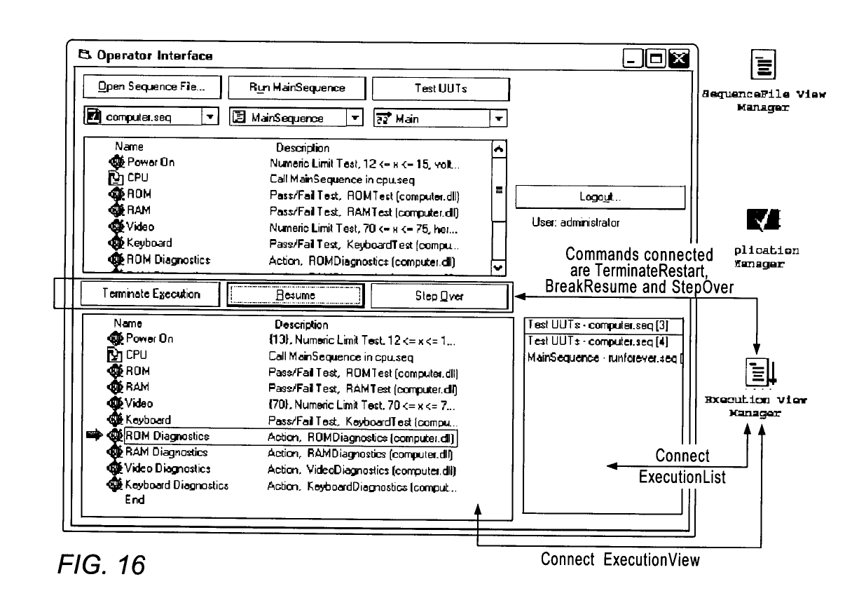

FIG. 16 is a screen shot illustrating the graphical user interface after the user has pressed the Break button shown in FIG. 15 to pause the execution. When the user presses the Break button, the Execution View Manager control executes to pause execution of the sequence. The Execution View Manager control also changes the appearance of the Break button to say “Resume” and enables the Step Over button.

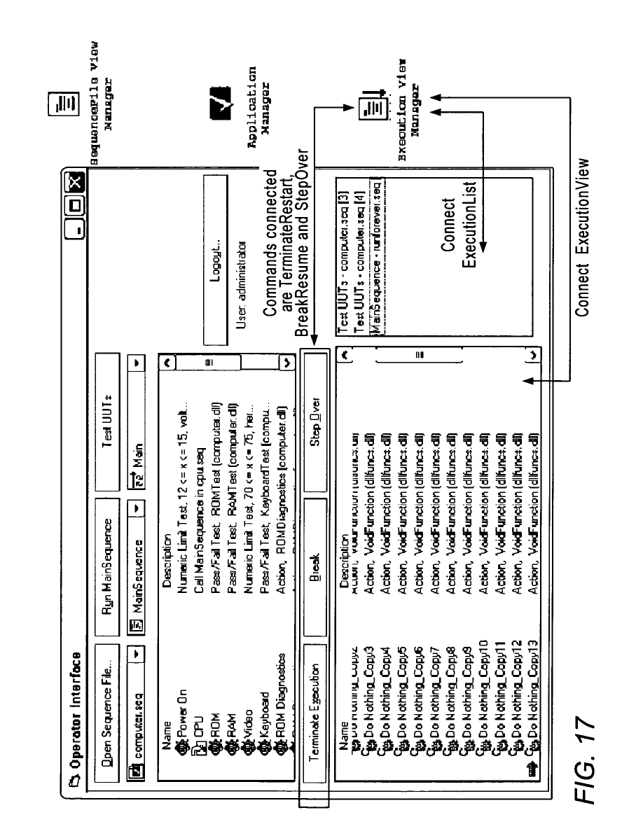

In FIG. 17, the user has changed the execution in the Execution List from “Test UUTs—computer seq [3]” to “MainSequence—runforever.seq”. As shown, when the user switches executions in the Execution List window, the Execution View Manager control executes to change the current sequence displayed in the Execution View window. The Execution View Manager also updates the buttons to reflect the state of this running execution.

Although the embodiments above have been described in considerable detail, numerous variations and modifications will become apparent to those skilled in the art once the above disclosure is fully appreciated. It is intended that the following claims be interpreted to embrace all such variations and modifications.

1. A computer-implemented method for creating a test executive application to perform a test executive function, the method comprising:
including a GUI element in the test executive application in response to user input;
including a control in the test executive application in response to user input, wherein the control includes pre-existing first functionality; and
configuring a binding between the GUI element and the control;
wherein the GUI element is operable to receive user input during execution of the test executive application;
wherein said configuring the binding between the GUI element and the control enables the control to automatically perform the first functionality in response to the user input received to the GUI element.

2. The method of claim 1,
wherein said configuring the binding between the GUI element and the control enables a user to configure the test executive application to perform the first functionality in response to user input received to the GUI element without requiring the user to program the test executive application to perform the first functionality.

3. The method of claim 1,
wherein said configuring the binding between the GUI element and the control enables a user to configure the test executive application to perform the first functionality in response to user input received to the GUI element without requiring the user to program the test executive application to respond to user input received to the GUI element.

4. The method of claim 1,
wherein said configuring the binding between the GUI element and the control enables a user to configure the test executive application to perform the first functionality in response to user input received to the GUI element without requiring the user to create program code to implement the first functionality.

5. The method of claim 1,
wherein the first functionality of the control includes test executive functionality;
wherein said configuring the binding between the GUI element and the control enables the control to automatically perform the test executive functionality in response to the user input received to the GUI element.

6. The method of claim 5,
wherein the test executive functionality comprises functionality for one or more of managing execution of a test executive sequence and/or displaying information regarding execution of the test executive sequence;
wherein said configuring the binding between the GUI element and the control enables the control to automatically manage execution of the test executive sequence and/or display information regarding execution of the test executive sequence in response to the user input received to the GUI element.

7. The method of claim 1,
wherein the test executive application is operable to execute a test executive sequence to perform one or more tests on one or more units under test (UUTs).

8. The method of claim 1,
wherein the test executive application comprises a run-time operator interface application for a test executive sequence.

9. The method of claim 8,
wherein the test executive sequence is associated with a test executive environment;
wherein the control is operable to call the test executive environment during execution of the run-time operator interface application to perform one or more of managing execution of the test executive sequence and/or displaying information regarding execution of the test executive sequence.

10. The method of claim 1,
wherein the first functionality of the control includes functionality for selecting a test executive sequence;
wherein said configuring the binding between the GUI element and the control enables the control to automatically perform the functionality for selecting a test executive sequence in response to the user input received to the GUI element.

11. The method of claim 10,
wherein the first functionality of the control also includes functionality for automatically displaying test executive steps of the test executive sequence in response to said selecting the test executive sequence.

12. The method of claim 1,
wherein the first functionality of the control includes functionality for invoking execution of a test executive sequence;
wherein said configuring the binding between the GUI element and the control enables the control to automatically invoke a test executive sequence in response to the user input received to the GUI element.

13. The method of claim 1,
wherein the first functionality of the control includes functionality for stopping execution of a test executive sequence;
wherein said configuring the binding between the GUI element and the control enables the control to automatically stop execution of a test executive sequence in response to the user input received to the GUI element.

14. The method of claim 1,
wherein the control comprises a standalone software component.

15. The method of claim 1,
wherein the GUI element appears on a graphical user interface of the test executive application during execution of the test executive application;
wherein the GUI element is operable to receive user input to the graphical user interface during execution of the test executive application.

16. The method of claim 15,
wherein the control does not appear on the graphical user interface of the test executive application during execution of the test executive application.

17. The method of claim 1,
wherein the control is a pre-existing control provided by an application development environment used to create the test executive application.

18. The method of claim 17, further comprising:
installing the application development environment on a computer system, wherein said installing the application development environment on the computer system comprises installing the control on the computer system.

19. The method of claim 17, further comprising:
installing the application development environment on a computer system;
installing the control on the computer system after said installing the application development environment on the computer system;
wherein said installing the control on the computer system enables the application development environment to provide a user with access to the control.

20. The method of claim 1, further comprising:
displaying a graphical user interface of an application development environment;
wherein the graphical user interface of the application development environment provides access to the GUI element and the control;
wherein said including the GUI element in the test executive application in response to user input comprises including the GUI element in the test executive application in response to user input to the graphical user interface of the application development environment;
wherein said including the control in the test executive application in response to user input comprises including the control in the test executive application in response to user input to the graphical user interface of the application development environment.

21. The method of claim 1,
wherein the GUI element comprises a first GUI element;
wherein the method further comprises:
including a second GUI element in the test executive application in response to user input; and
configuring a binding between the second GUI element and the control;
wherein the second GUI element is operable to display information during execution of the test executive application;
wherein said control performing the first functionality in response to the user input received to the first GUI element includes the control causing the second GUI element to display information based on the user input received to the first GUI element.

22. The method of claim 1,
wherein said configuring the binding between the GUI element and the control comprises performing one or more calls to bind the GUI element to the control during execution of the test executive application.

23. The method of claim 1,
wherein said configuring the binding between the GUI element and the control is performed in response to receiving user input to a graphical user interface to specify the binding between the GUI element and the control.

24. The method of claim 1, further comprising:
executing the test executive application;
receiving user input to the GUI element during execution of the test executive application; and
the control performing the first functionality in response to said receiving user input to the GUI element.

25. The method of claim 1,
wherein said including the GUI element in the test executive application comprises enabling the test executive application to utilize the GUI element during execution of the test executive application;
wherein said including the control in the test executive application comprises enabling the test executive application to utilize the control during execution of the test executive application.

26. The method of claim 1,
wherein said including the GUI element in the test executive application in response to user input comprises displaying the GUI element on a graphical user interface of the test executive application in response to user input.

27. The method of claim 1, further comprising:
configuring one or more properties of the control in response to user input.

28. The method of claim 27, further comprising program instructions operable to:
displaying a property panel for configuring the control; and
receiving user input to the property panel to configure the one or more properties of the control.

29. The method of claim 1,
wherein the control is a first control;
wherein the method further comprises including a second control in the test executive application in response to user input, wherein the second control includes pre-existing second functionality;
wherein said first control performing the first functionality includes the first control invoking the second control to perform the second functionality.

30. The method of claim 1,
wherein the GUI element comprises one or more of:
a button;
a text input element;
a check box;
a selection ring.

31. A computer-implemented method for creating a test executive application to perform a test executive function, the method comprising:
including a GUI element in the test executive application in response to user input, wherein the GUI element is operable to display information;
including a control in the test executive application in response to user input, wherein the control includes pre-existing first functionality, wherein the first functionality includes functionality for generating first information; and
configuring a binding between the GUI element and the control;
wherein said configuring the binding between the GUI element and the control enables the GUI element to automatically display the first information when the control performs the first functionality during execution of the test executive application.

32. The method of claim 31,
wherein said including the control in the test executive application enables a user to configure the test executive application to perform the first functionality without requiring the user to program the test executive application to perform the first functionality;
wherein said configuring the binding between the GUI element and the control enables the user to configure the test executive application to display the first information without requiring the user to program the test executive application to display the first information.

33. The method of claim 31,
wherein said including the control in the test executive application enables a user to configure the test executive application to perform the first functionality without requiring the user to create program code to implement the first functionality;
wherein said configuring the binding between the GUI element and the control enables the user to configure the test executive application to display the first information without requiring the user to create program code for displaying the first information.

34. The method of claim 31,
wherein the first functionality of the control includes test executive functionality;
wherein said configuring the binding between the GUI element and the control enables the GUI element to automatically display the first information when the control performs the test executive functionality during execution of the test executive application.

35. The method of claim 34,
wherein the test executive functionality comprises functionality for managing execution of a test executive sequence;
wherein the first information includes information regarding execution of the test executive sequence;
wherein said configuring the binding between the GUI element and the control enables the GUI element to automatically display the information regarding execution of the test executive sequence when the control performs the test executive functionality during execution of the test executive application.

36. The method of claim 31,
wherein the test executive application is operable to execute a test executive sequence to perform one or more tests on one or more units under test (UUTs).

37. The method of claim 31,
wherein the test executive application comprises a run-time operator interface application for a test executive sequence.

38. The method of claim 37,
wherein the test executive sequence is associated with a test executive environment;
wherein the control is operable to call the test executive environment during execution of the run-time operator interface application to generate the first information.

39. The method of claim 31,
wherein the first functionality of the control includes functionality for selecting a test executive sequence and generating a list of steps in the test executive sequence;
wherein said configuring the binding between the GUI element and the control enables the GUI element to automatically display the list of steps in the test executive sequence when the control selects the test executive sequence during execution of the test executive application.

40. The method of claim 31,
wherein the first functionality of the control includes functionality for generating a report regarding execution of a test executive sequence;
wherein said configuring the binding between the GUI element and the control enables the GUI element to automatically display the report during execution of the test executive application.

41. The method of claim 31,
wherein the first functionality of the control includes functionality for generating execution results of a test executive sequence;
wherein said configuring the binding between the GUI element and the control enables the GUI element to automatically display the execution results during execution of the test executive application.

42. The method of claim 31,
wherein the first functionality of the control includes functionality for generating information indicating an execution hierarchy for a test executive sequence;
wherein said configuring the binding between the GUI element and the control enables the GUI element to automatically display the execution hierarchy during execution of the test executive application.

43. The method of claim 31,
wherein the control comprises a standalone software component.

44. The method of claim 31,
wherein the GUI element appears on a graphical user interface of the test executive application during execution of the test executive application;
wherein the GUI element is operable to display information on the graphical user interface during execution of the test executive application.

45. The method of claim 44,
wherein the control does not appear on the graphical user interface of the test executive application during execution of the test executive application.

46. The method of claim 31,
wherein the control is a pre-existing control provided by an application development environment used to create the test executive application.

47. The method of claim 46, further comprising:
installing the application development environment on a computer system, wherein said installing the application development environment on the computer system comprises installing the control on the computer system.

48. The method of claim 46, further comprising:
installing the application development environment on a computer system;
installing the control on the computer system after said installing the application development environment on the computer system;
wherein said installing the control on the computer system enables the application development environment to provide a user with access to the control.

49. The method of claim 31,
wherein the GUI element comprises a first GUI element;
wherein the method further comprises:
including a second GUI element in the test executive application in response to user input; and
configuring a binding between the second GUI element and the control;
wherein the second GUI element is operable to receive user input during execution of the test executive application;
wherein said configuring the binding between the second GUI element and the control enables the control to automatically perform the first functionality in response to the user input received to the second GUI element, wherein said performing the first functionality includes generating the first information;
wherein said configuring the binding between the first GUI element and the control enables the first GUI element to automatically display the first information in response to the user input received to the second GUI element.

50. The method of claim 31,
wherein said configuring the binding between the GUI element and the control comprises performing one or more calls to bind the GUI element to the control during execution of the test executive application.

51. The method of claim 31,
wherein said configuring the binding between the GUI element and the control is performed in response to receiving user input to a graphical user interface to specify the binding between the GUI element and the control.

52. The method of claim 31, further comprising:
executing the test executive application;
the control performing the first functionality during execution of the test executive application, wherein said control performing the first functionality comprises the control generating the first information; and
the GUI element displaying the first information generated when the control performs the first functionality.

53. A computer-implemented method for creating a test executive application to perform a test executive function, the method comprising:
including a first GUI element in the test executive application, wherein the first GUI element is operable to receive user input during execution of the test executive application;
including a second GUI element in the test executive application, wherein the second GUI element is operable to display information during execution of the test executive application;
including a control in the test executive application, wherein the control includes pre-existing first functionality, wherein the first functionality includes functionality for generating first information;
configuring a binding between the first GUI element and the control;
configuring a binding between the second GUI element and the control;
wherein said configuring the binding between the first GUI element and the control enables the control to automatically perform the first functionality in response to the user input received to the first GUI element during execution of the test executive application, wherein said performing the first functionality includes generating the first information;
wherein said configuring the binding between the second GUI element and the control enables the second GUI element to automatically display the first information when the control performs the first functionality in response to the user input received to the first GUI element.

54. A computer-implemented method for creating a test executive application to perform a test executive function, the method comprising:
including a GUI element in the test executive application;
including a control in the test executive application; and
configuring a binding between the GUI element and the control;
wherein the GUI element is operable to receive user input during execution of the test executive application;
wherein said configuring the binding between the GUI element and the control enables the control to automatically respond to the user input received to the GUI element.

55. The method of claim 54,
wherein the GUI element is a first GUI element;
wherein the method further comprises:
including a second GUI element in the test executive application; and
configuring a binding between the second GUI element and the control;
wherein the second GUI element is operable to display information for the test executive application;
wherein said control responding to the user input received to the first GUI element includes the control causing the second GUI element to display information based on the user input received to the first GUI element.

56. A computer-implemented method for creating a software measurement application to perform a measurement function, the method comprising:
including a GUI element in the measurement application in response to user input;
including a control in the measurement application in response to user input, wherein the control includes pre-existing first functionality; and
configuring a binding between the GUI element and the control;
wherein the GUI element is operable to receive user input during execution of the measurement application;
wherein said configuring the binding between the GUI element and the control enables the control to automatically perform the first functionality in response to the user input received to the GUI element.

57. The method of claim 56,
wherein said configuring the binding between the GUI element and the control enables a user to configure the measurement application to perform the first functionality in response to user input received to the GUI element without requiring the user to program the measurement application to perform the first functionality.

58. The method of claim 56,
wherein said configuring the binding between the GUI element and the control enables a user to configure the measurement application to perform the first functionality in response to user input received to the GUI element without requiring the user to program the measurement application to respond to user input received to the GUI element.

59. The method of claim 56,
wherein said configuring the binding between the GUI element and the control enables a user to configure the measurement application to perform the first functionality in response to user input received to the GUI element without requiring the user to create program code to implement the first functionality.

60. The method of claim 56,
wherein the first functionality of the control includes measurement functionality;
wherein said configuring the binding between the GUI element and the control enables the control to automatically perform the measurement functionality in response to the user input received to the GUI element.

61. The method of claim 56,
wherein the control is a pre-existing control provided by an application development environment used to create the measurement application.

62. The method of claim 56,
wherein the GUI element comprises a first GUI element;
wherein the method further comprises:
including a second GUI element in the measurement application in response to user input; and
configuring a binding between the second GUI element and the control;
wherein the second GUI element is operable to display information during execution of the measurement application;
wherein said control performing the first functionality in response to the user input received to the first GUI element includes the control causing the second GUI element to display information based on the user input received to the first GUI element.

63. A computer-implemented method for creating a software measurement application to perform a measurement function, the method comprising:
including a GUI element in the measurement application in response to user input, wherein the GUI element is operable to display information;
including a control in the measurement application in response to user input, wherein the control includes pre-existing first functionality, wherein the first functionality includes functionality for generating first information; and
configuring a binding between the GUI element and the control;
wherein said configuring the binding between the GUI element and the control enables the GUI element to automatically display the first information when the control performs the first functionality during execution of the measurement application.

64. The method of claim 63,
wherein said including the control in the measurement application enables a user to configure the measurement application to perform the first functionality without requiring the user to program the measurement application to perform the first functionality;
wherein said configuring the binding between the GUI element and the control enables the user to configure the measurement application to display the first information without requiring the user to program the measurement application to display the first information.

65. The method of claim 63,
wherein said including the control in the measurement application enables a user to configure the measurement application to perform the first functionality without requiring the user to create program code to implement the first functionality;
wherein said configuring the binding between the GUI element and the control enables the user to configure the measurement application to display the first information without requiring the user to create program code for displaying the first information.

66. The method of claim 63,
wherein the first functionality of the control includes measurement functionality;
wherein said configuring the binding between the GUI element and the control enables the GUI element to automatically display the first information when the control performs the measurement functionality during execution of the measurement application.

67. The method of claim 63,
wherein the control is a pre-existing control provided by an application development environment used to create the measurement application.

68. The method of claim 63,
wherein the GUI element is a first GUI element;
wherein the method further comprises:
including a second GUI element in the measurement application in response to user input; and
configuring a binding between the second GUI element and the control;
wherein the second GUI element is operable to receive user input during execution of the measurement application;
wherein said configuring the binding between the second GUI element and the control enables the control to automatically perform the first functionality in response to the user input received to the second GUI element, wherein said performing the first functionality includes generating the first information;
wherein said configuring the binding between the first GUI element and the control enables the first GUI element to automatically display the first information in response to the user input received to the second GUI element.

69. A computer-implemented method for creating a measurement application to perform a measurement function, the method comprising:
including a first GUI element in the measurement application, wherein the first GUI element is operable to receive user input during execution of the measurement application;
including a second GUI element in the measurement application, wherein the second GUI element is operable to display information during execution of the measurement application;
including a control in the measurement application, wherein the control includes pre-existing first functionality, wherein the first functionality includes functionality for generating first information;
configuring a binding between the first GUI element and the control;
configuring a binding between the second GUI element and the control;
wherein said configuring the binding between the first GUI element and the control enables the control to automatically perform the first functionality in response to the user input received to the first GUI element during execution of the measurement application, wherein said performing the first functionality includes generating the first information;
wherein said configuring the binding between the second GUI element and the control enables the second GUI element to automatically display the first information when the control performs the first functionality in response to the user input received to the first GUI element.

70. A computer-implemented method for creating a software application, the method comprising:
including a GUI element in the application in response to user input;
including a control in the application in response to user input, wherein the control includes pre-existing first functionality; and
configuring a binding between the GUI element and the control;
wherein the GUI element is operable to receive user input during execution of the application;
wherein said configuring the binding between the GUI element and the control enables the control to automatically perform the first functionality in response to the user input received to the GUI element.

71. The method of claim 70,
wherein said configuring the binding between the GUI element and the control enables a user to configure the application to perform the first functionality in response to user input received to the GUI element without requiring the user to program the application to perform the first functionality.

72. A computer-implemented method for creating a software application, the method comprising:
including a GUI element in the application in response to user input, wherein the GUI element is operable to display information;
including a control in the application in response to user input, wherein the control includes pre-existing first functionality, wherein the first functionality includes functionality for generating first information; and
configuring a binding between the GUI element and the control;
wherein said configuring the binding between the GUI element and the control enables the GUI element to automatically display the first information when the control performs the first functionality during execution of the application.

73. The method of claim 72,
wherein said including the control in the application enables a user to configure the application to perform the first functionality without requiring the user to program the application to perform the first functionality;
wherein said configuring the binding between the GUI element and the control enables the user to configure the application to display the first information without requiring the user to program the application to display the first information.

74. A computer-implemented method for creating a software application, the method comprising:
including a first GUI element in the application, wherein the first GUI element is operable to receive user input during execution of the application;
including a second GUI element in the application, wherein the second GUI element is operable to display information during execution of the application;
including a control in the application, wherein the control includes pre-existing first functionality, wherein the first functionality includes functionality for generating first information;
configuring a binding between the first GUI element and the control;
configuring a binding between the second GUI element and the control;
wherein said configuring the binding between the first GUI element and the control enables the control to automatically perform the first functionality in response to the user input received to the first GUI element during execution of the application, wherein said performing the first functionality includes generating the first information;
wherein said configuring the binding between the second GUI element and the control enables the second GUI element to automatically display the first information when the control performs the first functionality in response to the user input received to the first GUI element.

75. A computer-implemented method for creating a simulation application to perform a simulation function, the method comprising:
including a GUI element in the simulation application in response to user input;
including a control in the simulation application in response to user input, wherein the control includes pre-existing simulation functionality; and
configuring a binding between the GUI element and the control;
wherein the GUI element is operable to receive user input during execution of the simulation application;
wherein said configuring the binding between the GUI element and the control enables the control to automatically perform the simulation functionality in response to the user input received to the GUI element.
